(19) United States
(12) Patent Application Publication
(10) Pub. No.: US 2022/0222577 A1
(43) Pub. Date: Jul. 14, 2022

(54) Computer-Implemented Methods and Systems for Detecting State in Application Services

(71) Applicant: CyGlass, Inc., Littleton, MA (US)

(72) Inventors: Anindya Roy, Nashua, NH (US); Salvador Barragan, New York, NY (US); Ramesh Natarajan, Lincoln, MA (US); Eugen Panaitescu, Brookline, MA (US); Li LI, Acton, MA (US); Josh Bregman, Acton, MA (US)

(21) Appl. No.: 17/569,636

(22) Filed: Jan. 6, 2022

Related U.S. Application Data
(60) Provisional application No. 63/135,583, filed on Jan. 9, 2021.

(51) Int. Cl. G06N 20/00

(52) U.S. Cl. CPC G06N 20/00

(57) ABSTRACT

A computer-implemented system and method, referred to as a Service State Discovery Engine (SSDE), continuously ingests data (such as netflow data) related to a network application service. The SSDE aggregates the ingested data and evaluates the data to identify a state and corresponding nature (e.g., scale) of the network application service. The SSDE identifies changes in the state, and scale of the state, of the network application service over time.

### BACKGROUND

Communication networks face an increasing variety of increasingly-sophisticated and evolving threats. A variety of techniques exist for identifying such threats by establishing a baseline of healthy network activity and then identifying unhealthy activity by comparing ongoing activity relative to the baseline. Such existing techniques, however, have a variety of limitations which result in failure to identify all threats. What is needed, therefore, are improved techniques for automatically identifying unhealthy network activity on an ongoing basis.

### SUMMARY

A computer-implemented system and method, referred to as a Service State Discovery Engine (SSDE), continuously ingests data (such as netflow data) related to a network application service. The SSDE aggregates the ingested data and evaluates the data to identify a state and corresponding nature (e.g., scale) of the network application service. The SSDE identifies changes in the state, and scale of the state, of the network application service over time.

Other features and advantages of various aspects and embodiments of the present invention will become apparent from the following description and from the claims.

### BRIEF DESCRIPTION OF THE DRAWINGS

FIG. 1 is a diagram illustrating a model of a network application service according to one embodiment of the present invention.

FIG. 2 is a state transition diagram of a Service State Discovery Engine (SSDE) according to one embodiment of the present invention.

FIG. 3 is a diagram of the operation of an embodiment of the present invention; and

FIG. 4 is a dataflow diagram illustrating the operation of the SSDE according to one embodiment of the present invention.

### DETAILED DESCRIPTION

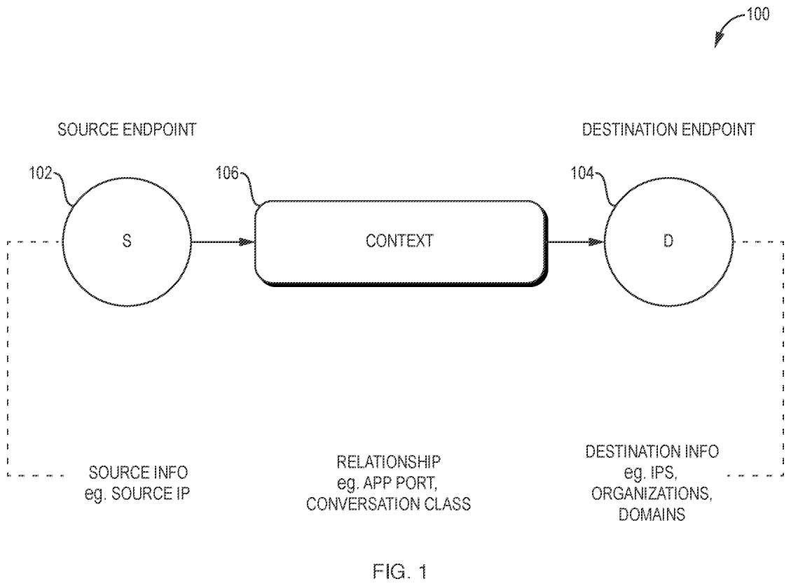

Referring to FIG. 1, a diagram is shown of a model 100 of a network-based application service (also referred to herein simply as a “service”) according to one embodiment of the present invention. The service model 100 includes data representing: a source endpoint 102, a destination endpoint 104, and a context 106 that describes the association between the source endpoint 102 and the destination endpoint 104. In practice, an “endpoint,” as that term is used herein (e.g., in connection with the source endpoint 102 and/or the destination endpoint 104) may be implemented in any of a variety of ways. For example, an endpoint may be a software application executing on a computer. As this example illustrates, the service model 100 of FIG. 1 may be used to represent an application. For example, an anti-virus application may be modeled by the service model 100 as having two endpoints: (1) a first endpoint running in a computer; and (2) a second endpoint running in a remote computer, such as in the cloud.

In the context of FIG. 1, the source application endpoint 102 may, for example, be a first (source) application executing on a first computer, and the destination endpoint 104 may, for example, be a second (destination) application executing on a second computer. The source application may have a first (source) network address (e.g., IP address), and the destination application may have a second (destination) network address (e.g., IP address). The source and destination applications may address each other using their respective network addresses, and may transmit messages to and from each other via their respective computers over the network. The network application service that is modeled by the model 100 may, for example, be the source endpoint 102 and/or the destination endpoint 104.

The source endpoint 102 and/or destination endpoint 104 need not, however, be applications. Alternatively, for example, either or both of them may be computers, network adapters, or any other network addressable software and/or hardware resource that performs the endpoint functions disclosed herein. More generally, the source endpoint 102 and/or destination endpoint 104 may be any two elements (e.g., computer hardware, computer software, and/or humans) that communicate or otherwise interact with each other. For example, a Microsoft 365 user may be the source endpoint 102 and a file stored in Microsoft 365 may be the destination endpoint 104. The context 106 may represent interactions between the user and the file, such as opening the file, editing the file, or sharing the file.

The context 106 may be represented within the service model 100 by data (referred to herein as “context data”) representing any of a variety of contextual information relating to the source endpoint 102, the destination endpoint 104, and the association between the source endpoint 102 and the destination endpoint 104. In general, the context 106 may include one or a plurality of unique parameters that identify the service represented by the service model 100 uniquely. For example, the context data may include data representing a port of the source endpoint 102 (a “source port”) and/or data representing a port of the destination endpoint 104 (a “destination port”). The source endpoint 102 may, for example, address the destination endpoint 104 using a combination of the destination endpoint 104's IP address and port, and the destination endpoint 104 may, for example, address the source endpoint 102 using a combination of the source endpoint 102's IP address and port.

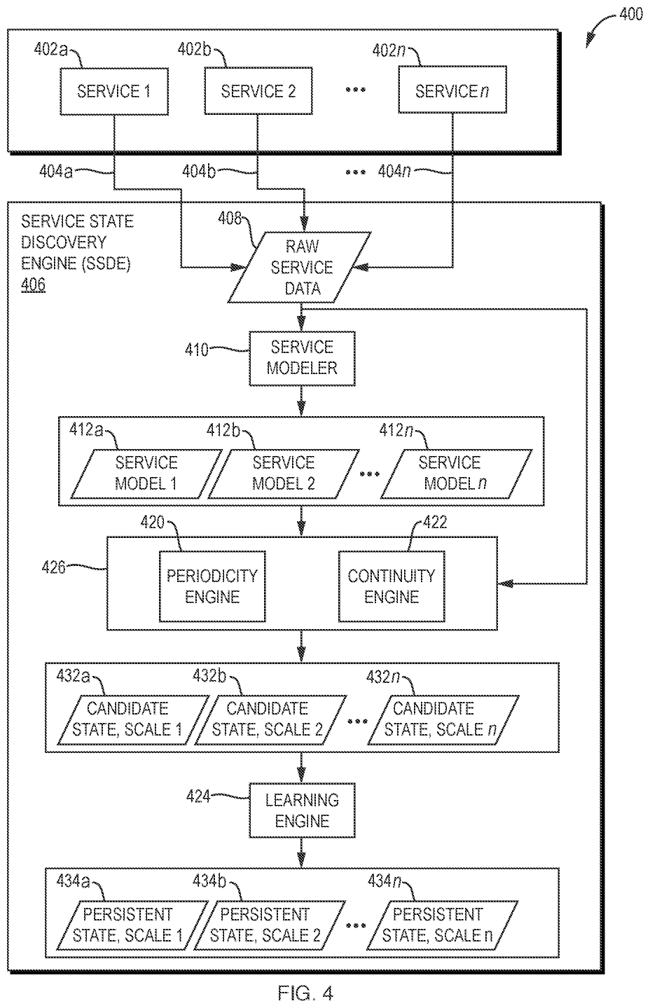

The service model 100 models (represents) a particular service, such as a particular network application service. As illustrated by the system 400 of FIG. 4, embodiments of the present invention may generate and store the service model 100 by, for example, ingesting any type of data relating to the modeled network application service, such as data representing activity (or lack of activity) of the modeled network application service, and then generating the service model 100 based on the ingested data. (Terms such as “ingest,” “consume,” and “gather” are used synonymously herein and include, in relation to data, receiving such data as input.)

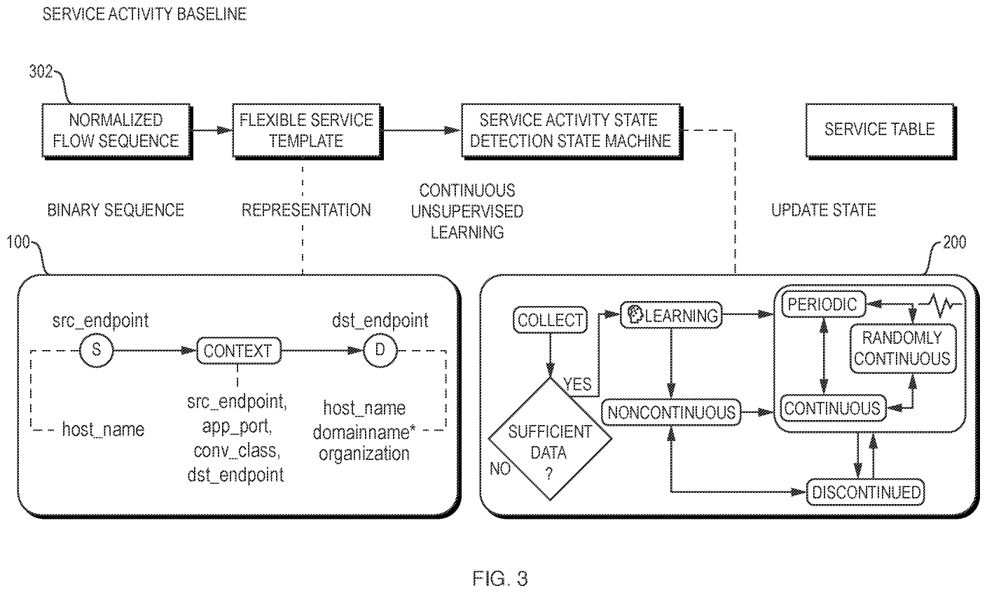

For example, the system 400 of FIG. 4 includes a plurality of services 402a-n, where n may be any number. The system 406 includes an embodiment of a Service State Discovery Engine (SSDE) 406, which ingests data 404a-n from the corresponding services 402a-n, respectively. The data 404a-n ingested from the services 402a-n by the SSDE 406 are shown collectively within the SSDE 406 as raw service data 408 (also shown in FIG. 3 as normalized flow sequence 302). As described in more detail herein, the SSDE 406 may include a service modeler 410, which may generate and store, for each of the services 402a-n, based on the raw service data 408, a corresponding service model of the type shown in FIG. 1. For example, the service modeler 410 may generate and store: (1) a service model 412a representing service 402a, based on the ingested service data 404a from service 402a; (2) a service model 412b representing service 402b, based on the ingested service data 404b from service 402b; and (3) a service model 412n representing service 402n, based on the ingested service data 404n from service 402n.

One non-limiting example of the data 404a-n that may be ingested by the SSDE 406 is netflow data, in which the modeled service is the source endpoint 102 and/or the destination endpoint 104. The ingested data 404a-n may include, for example, network connection requests between the source endpoint 102 and destination endpoint 104 of any of the services 402a-n, and messages transmitted and received by the source endpoint 102 and destination endpoint 104 of any of the services 402a-n over the network. More generally, each of the modeled services 402a-n may, for example, be any kind of network activity, and the ingested data 404a-n relating to the modeled service 402a-n may be any kind of data relating to the modeled services 402a-n, such as data representing messages transmitted to and/or from the modeled services 402a-n. As another example, the ingested data 404a-n relating to the modeled services 402a-n may include data indicating whether, at a particular time or during a particular time interval, the corresponding modeled service was engaged in activity (e.g., transmitting and/or receiving messages) over a network. Such data may include, for example, a binary value indicating whether or not the service was engaged in activity over the network at the particular time or during the particular time interval. As a result, in this example, the raw service data 408 may include, for each of the services 402a-n, binary data containing bits indicating, for each of a plurality of times or time intervals, whether that service was engaged in activity over the network at the particular time or during the particular time interval. For example, a value of 1 may represent presence of activity of the service, whereas a value of 0 may represent absence of activity of the service. As a result, the raw service data 408 may include a historical record of data (e.g., a sequence of binary data) derived from some or all of the service data 404a-n over time. As the examples above illustrate, the ingested data (and resulting raw service data 408) may include a plurality of data elements representing any of the data described above or elsewhere herein for a plurality of particular times and/or a plurality of time intervals. Similarly, any function disclosed herein as being performed in connection with a particular time or time interval should be understood to disclose also performing such a function at a plurality of particular times and/or time intervals. For example, any disclosure herein of generating and/or updating a model of a particular service (such as any of the models 412a-n) at a particular time or time interval should be understood to disclose also generating and/or updating that model at a plurality of times and/or time intervals. For example, as the SSDE 406 400 receives additional service data 404a-n from the services 402a-n (i.e., service data received after the initial service data that was used by the system 400 to generate the initial service models 412a-n), the SSDE 406 may update the models 412a-n repeatedly over time based on such newly-ingested data. Embodiments of the present invention may store both the updated versions of the service models 412a-n and previous versions of the models 412a-n, thereby storing a historical record of the models 412a-n over time.

Any description herein of functions that are performed by, or in connection with, the service model 100, should be understood to be applicable to a plurality of such service models corresponding to a plurality of distinct services, such as the plurality of service models 412a-n corresponding to the plurality of services 402a-n in FIG. 4.

Although the raw service data 408 and the service models 412a-n are shown as distinct elements in FIG. 4, this is merely an example and does not constitute a limitation of the present invention. For example, some or all of the raw service data 408 collected from a particular one of the services 402a-n may be stored by the SSDE 406 in the corresponding one of the service models 412a-n for that service. For example, the SSDE 406 may store some or all of the raw service data 408 collected from service 402a in the service model 412a for service 402a. Similarly, the SSDE 406 may store some or all of the raw service data 408 collected from service 402b in the service model 412b for service 402b. As the SSDE 406 continues to collect additional raw service data 408 from the services 402a-n over time, the SSDE 406 may store some or all of the data collected from those services 402a-n into their corresponding service models 412a-n. As a result, the service models 412a-n may include a historical record of the raw service data 408 collected from their corresponding services 402a-n, respectively.

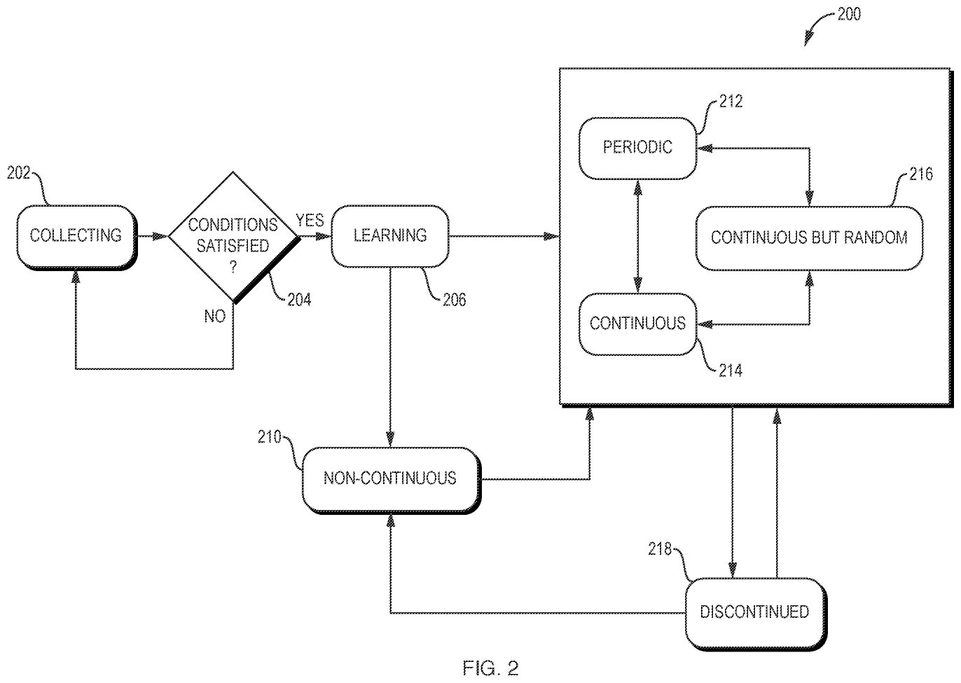

As mentioned in connection with FIG. 4, embodiments of the present invention include the Service State Discovery Engine (SSDE) 406, which may be used to continuously learn, identify, store, and update the state of one or more services 402a-n represented by corresponding service models 412a-n of the type shown in FIG. 1. As will be described below, the SSDE 406 may include various components, such as a Periodicity Engine 420, a Continuity Engine 422, and a Learning Engine 424. Referring to FIG. 2, a state diagram 200 is shown which illustrates transitions among states of the SSDE 406 as the SSDE 406 learns and identifies the state of a service represented by a service model of the type shown in FIG. 1.

In general, the SSDE 406 monitors and ingests data 404a-n (e.g., netflow data) related to the services 402a-n represented by the service models 412a-n. As will be described in more detail below, in general, the SSDE 406 performs two steps: (1) identify the latest state and scale of the monitored services 402a-n; and (2) analyze the historical record of each of the services' state and scale to determine whether that historical record indicates a consistency of state and/or scale over time.

Any reference herein to the SSDE 406 (or any component thereof, such as the Periodicity Engine 420, Continuity Engine 422, or Learning Engine 424) “entering” or “transitioning” into a state, or “assigning” a state to a service, should be understood to encompass storing a record of that state in the state's service model and/or in data associated with the service in the state/scale data 432a-n/434a-n.

The SSDE 406 also includes a Periodicity Engine 420 and a Continuity Engine 422, which are examples of “detection engines,” as that term is used herein. The Periodicity Engine and Continuity Engine 422 may receive, as input, the raw service data 408 and/or the service models 412a-n, and, based on such data, the Periodicity Engine 420 and the Continuity Engine 422 may identify, for each of the services 402a-n, a current state and corresponding candidate scale of that state (shown in FIG. 4 as state/scale pairs 432a-n, corresponding to services 402a-n, respectively). As the SSDE 406 ingests additional service data 404a-n over time and updates the service models 412a-n over time as a result, the Periodicity Engine 420 and Continuity Engine 422 may receive such new service data 404a-n and updated service models 412a-n and generate additional state/scale pairs corresponding to each of the services 402a-n. The Periodicity Engine 420 and Continuity Engine 422 may store such additional state/scale pairs in the state/scale data 432a-n. As a result, the candidate state/scale data 432a-n may include not only a current candidate state/scale for each of the services 402a-n, but also a historical record of candidate state/scale pairs for each of the services 402a-n. Any two state/scale pairs within the candidate state/scale data 432a-n may have the same or different values than each other. For example, a first and second state/scale pair within the data 432a-n may have the same or different state value as each other, and/or the same or different scale value as each other.

Although the service models 412a-n and the corresponding candidate state/scale data 432a-n are shown as distinct elements in FIG. 4, this is merely an example and does not constitute a limitation of the present invention. For example, some or all of the candidate state/scale data 432a-n may be stored in their corresponding service models 412a-n. For example, the SSDE 406 may store some or all of the candidate state/scale data 432a in the service model 412a for service 402a. Similarly, the SSDE 406 may store some or all of the candidate state/scale data 432b in the service model 412b for service 402b.

The states and corresponding scales stored in the state/scale data 432a-n each correspond to a particular time or time period. The Learning Engine 424 receives the state/scale data 432a-n and, based on that data 432a-n, identifies a persistent state and scale for each of the services 402a-n, and stores those persistent states and scales in persistent state/scale data 434a-n corresponding to services 402a-n. As the detection engines 426 update the candidate state/scale data 432a-n with additional candidate states/scales 432a-n over time as the SSDE 406 ingests additional service data 404a-n, the learning engine 424 may generate, based on the updated candidate states/scales 432a-n, updated persistent states/scales 434a-n. As a result, the persistent state/scale data 434a-n may include not only a current persistent state/scale for each of the services 402a-n, but also a historical record of persistent states/scales for each of the services 402a-n. Any two state/scale pairs within the persistent state/scale data 434a-n may have the same or different values than each other. For example, a first and second state/scale pair within the data 434a-n may have the same or different state value as each other, and/or the same or different scale value as each other.

Although the candidate state/scale data 432a-n and the persistent state/scale data 434a-n are shown as distinct elements in FIG. 4, this is merely an example and does not constitute a limitation of the present invention. For example, the candidate state/scale data 432a and the persistent state/scale data 434a may be implemented as a single set of data, which the SSDE 406 updates over time using the techniques disclosed herein. As the SSDE 406 identifies a new current state of the service 402a using the techniques disclosed herein, the SSDE 406 may store a record of that state in such a combined state/scale dataset, thereby updating a historical record of such states/scales. The same is true of the candidate state/scale data 432b and the persistent state/scale data 434b and their corresponding service 402b, and for the candidate state/scale data 432n and the persistent state/scale data 434n and their corresponding service 402n. Furthermore, as described above, all such combined state/scale data may be stored in the corresponding one of the service models 412a-n. As a result, the service models 412a-n may store a historical record of candidate and persistent states for the corresponding services 402a-n, respectively.

Any of the data disclosed herein as being collected and/or generated over time (e.g., the service data 404a-n, raw service data 408, service models 412a-n, candidate state/scale data 432a-n, and persistent state/scale data 434a-n) may include timestamps and/or sequence data indicating times and/or sequence values associated with the data contained therein. For example, the raw service data 408 may include, for each of the plurality of services 402a-n: (1) a sequence of binary data representing the presence or absence of the service at a corresponding time; and (2) a timestamp or sequence value representing the corresponding time.

The “scale” of a state of a service at a particular time (or during a particular interval of time) may, for example, represent a range (e.g., maximum range) of time over which the SSDE 406 evaluated the service's state to identify that state. For example, if the SSDE evaluates the service for continuity over at most a 24-hour period, then the scale of the state of that service during that period of evaluation is 24 hours. During that 24-hour period, the SSDE 406 may evaluate the service for continuity at any frequency that is less than 24 hours (e.g., a frequency of 30 minutes, 1 hour, 2 hours, or 4 hours). As will be described in more detail below, “evaluating the service” refers to analyzing ingested data relating to the service (and, in some embodiments, data in addition to the ingested data) in order to identify a state of the service, and in some situations to identify other features of the service (such as the scale of the state of the service).

For example, during the first 24 hours in which the SSDE 406 evaluates a service, the SSDE 406 may assign a scale of 24 hours to the state of the service. After the first 24 hours of evaluation through the end of the first week of evaluation, the SSDE 406 may assign a scale of one week to the state of the service. After the first week of evaluation through the end of the first month of evaluation, the SSDE 406 may assign a scale of one month to the state of the service. After the first month of evaluation, the SSDE 406 may assign a scale of three months to the state of the service.

These particular scales are merely examples and do not constitute limitations of the present invention. As the examples above illustrate, the SSDE 406 may assign a first scale to the state of a service during a first time period (e.g., the first 24 hours in which the SSDE evaluates the service), and may assign a second scale (which differs from the first scale) to the state of the service during a second time period that is after the first time period (e.g., the second through seventh day in which the SSDE evaluates the service). The same is true for any number of time periods in which the SSDE 406 evaluates the state of the service.

Within any particular scale that the SSDE 406 assigns to a state of a service, the SSDE may assign one or a plurality of target reference frequencies (also referred to herein simply as “frequencies”) to that scale. Furthermore, for each such target reference frequency, the SSDE 406 may assign a corresponding reference probability. The SSDE 406 may store data representing such target reference frequencies and corresponding reference probabilities, e.g., within the state/scale data 432a-n and/or the state/scale data 434a-n. When the SSDE 406 determines continuity in a given scale for a given state of a service, the SSDE 406 may calculate the sample probability and identify the frequency of continuity by comparing with a predetermined set of reference probabilities and corresponding frequencies.

As implied by the description above, the amount of data that the SSDE 406 has ingested for a particular service imposes a limit on the scale against which the SSDE 406 may evaluate the service. For example, if the SSDE 406 has only ingested 24 hours of data for the service, then the SSDE 406 may only evaluate the service for continuity with a scale of 24 hours or less. Similarly, if the SSDE 406 has only ingested 7 days of data for the service, then the SSDE 406 may only evaluate the service for continuity with a scale of 7 days or less.

The way in which the Periodicity Engine 420, the Continuity Engine 422, and Learning Engine 424 operate relies on the latest state and scale of the service being evaluated (i.e., the most recent state and scale that the SSDE 406 has identified and/or assigned to the service, as reflected in the state/scale data 432a-n and the 434a-n). For example, at the beginning, when the SSDE 406 has begun to ingest data relating to a service (e.g., any of the services 402a-n) but has not yet assigned a persistent state to that service, the SSDE 406 may apply unsupervised learning to the ingested data relating to the service to identify the current state of the service. In this situation, the input sample space is unconstrained, and the SSDE 406 evaluates the service on all possible scales (or any plurality of scales). Once the SSDE 406 has determined that the service has a state of Continuous or Periodic, the SSDE 406 may, in response to such a determination, apply supervised learning to ingested data relating to the service (including data that is ingested after the SSDE 406 determined that the service had a state of Continuous or Periodic) to determine whether the service has maintained its current behavior (e.g., its previous state of Continuous or Periodic, or its previous period if in the state of Periodic) or whether the service has undergone a change (e.g., a change from its previous state of Continuous or Periodic, or a change from one period to a different period while retaining the state of Periodic). By using supervised learning, the SSDE 406 constrains the input sample space such that the input sample space matches the originally discovered scale. This constraint allows the SSDE 406 to evaluate whether the state and/or scale of the service has stayed the same or changed over time.

This process is illustrated in FIG. 2, which shows a state machine that may be implemented by the SSDE 406 according to one embodiment of the present invention. As described above, the SSDE 406 begins in a “Collecting” state 202, in which the SSDE 406 ingests service data 404a-n from the services 402a-n. The “Collecting” state 202 is an unsupervised state, which is the initial state that the SSDE 406 assigns to a service upon initiating data-gathering for that service. For example, when the SSDE 406 begins ingesting data for a particular service, the SSDE 406 may be in the Collecting state 202 and assign the Collecting state 202 to the service (and store a record of that state in the service's state/scale data 432a-n), and may remain in the Collecting state 202 until the SSDE has gathered some minimum amount of data for the service, which is shown in FIG. 2 as condition 204 being satisfied.

Once condition 204 has been satisfied, the SSDE 406 enters a “Learning” state 206 and assigns the Learning state to the service (and stores a record of that state in the service's state/scale data 432a-n). While in this state, the learning engine 424 performs the functions described above. The Learning state is an unsupervised state 206, in which the SSDE 406 evaluates the service for potential periodicity and continuity (i.e., to determine whether to assign a state of Periodic or Continuous to the service) using the Periodicity and Continuity Detection Engines. While the SSDE 406 is in the Learning state, the SSDE's Learning Engine 424 searches for stability in the service's state and scale by evaluating over the historical state-scale evaluations 432a-n/434a-n collected for the service so far. For example, the Learning Engine may analyze the historical state-scale evaluations 432a-n/434a-n of the service and determine whether such evaluations satisfy some consistency criterion.

If the SSDE 406 determines that a service does not regularly occur in a stable, predictable fashion (e.g., if the Learning Engine 424 determines that the service's historical state-scale evaluations 312 do not satisfy the consistency criterion), then the SSDE 406 may transition into a “Non-Periodic” unsupervised state (not shown in FIG. 2). The SSDE 406 treats the Non-Periodic state like a learning state, allowing the SSDE 406 to identify any updates to a service's behavior. The Non-Periodic state may be a transitional state and, as a result, the SSDE 406 may or may not store a record indicating that the service is or was in the Non-Periodic State (e.g., in the service's model 412a-n).

If the SSDE 406 determines that a service does not occur regularly over time, then the SSDE 406 transitions into a “Non-Continuous” unsupervised state 210 and assigns the Non-Continuous state 210 to the service. The SSDE 406 treats this state like a learning state in subsequent runs, i.e., the SSDE 406 uses the Non-Continuous unsupervised state 210 to determine which type of evaluation to perform on the service in subsequent runs.

If a service was previously in a Periodic state 212, a Continuous state 214, or a Continuous but Random state 216 (see below), and the SSDE 406 subsequently determines (based on newly-ingested data relating to the service, possibly in addition to previously-ingested data) that the service is determined to exhibit behavior that would qualify it for the Non-Periodic state or Non-Continuous state 210, then the SSDE 406 transitions into a “Discontinued” unsupervised state 218 and assigns the Discontinued state 218 to the service. In other words, when the SSDE 406 determines that a service in a Periodic, Continuous, or Continuous but Random state subsequently fails to exhibit behavior (based on its ingested data) that would qualify the service for the same state, the SSDE 406 changes, in response to that determination, the state of the service to Discontinued.

Examples of supervised states will now be described. These are latched states, which limit the SSDE 406's subsequent analysis, making assumptions of state and/or scale.

If the Periodicity Engine 420 has produced state/scale data indicating that a service occurs at a certain frequency and/or scale, and the Learning Engine 424 has found sufficient evidence that this pattern is persistent over time (e.g., that the service has remained in the same frequency and/or scale for at least some minimum amount of time), then the SSDE 406 transitions into a “Periodic” supervised state 212 and assigns the Periodic state 212 to the service. In other words, once a service has achieved stability of state and scale, the SSDE 406 concludes that the service is periodic at a certain scale, as reflected in the service's state/scale data 432a-n/434a-n.

If the Periodicity Engine 420 has produced state/scale data indicating that a service repeatedly occurs at a certain frequency, but the Learning Engine 424 has not found sufficient evidence that this pattern is persistent over time (e.g., over at least some minimum amount of time), then the SSDE 406 transitions into a “Continuous” supervised state 214 and assigns the Continuous state 214 to the service. Unlike a Periodic service, a Continuous service does not exhibit strong evidence of a neat, predictable pattern over time.

If the Periodicity Engine 420 has produced state-nature data indicating that a service occurs regularly, but the Learning Engine 424 concludes that the service occurs at an inconsistent frequency (e.g., at a frequency that varies over a plurality of scales), then the SSDE 406 transitions into a “Continuous but Random” supervised state 216 and assigns the Continuous but Random supervised state 216 to the service. A service that is Continuous but Random has a stability of state, but not of scale. For example, if the service is observed during a first time interval to have a first frequency at a first scale, and is observed during a second time interval (that occurs later than the first time interval) to have a second frequency (which differs from the first frequency) at a second scale (which differs from the first scale), then the SSDE 406 may, in response to identifying the difference between the first frequency at the first scale and the second frequency at the second scale, assign the Continuous but Random state 216 to the service.

If the Periodicity Engine 420 has produced state/scale data indicating that a service was in the Continuous or Periodic state at a first scale, and the Learning Engine 424 concludes that the service subsequently displayed the same Continuous or Periodic behavior, but at a second scale that differs from the first scale, then the SSDE 406 transitions into a Mutated supervised state and assigns the Mutated state to the service. As the SSDE 406 continues to observe the behavior of the service over time (e.g., ingest additional data relating to the service over time), the SSDE 406 will transition the service into the Periodic, Continuous, or Continuous but Random state, depending on the observed behavior of the service.

The SSDE 406 may assign states to a service by using a pattern searching algorithm that balances recent analysis with historical trends. The SSDE 406 may discover candidate states by utilizing the Periodicity Engine 420 and the Continuity Engine 308. The Learning Engine 424 may then analyze the historical outputs 312 of the Periodicity Engine 420 and the Continuity Engine 308 for stability of state and scale before assigning a final, resting state to a service.

Once a service has passed from the Learning state 206 into a state other than the Learning state 206, the SSDE 406's sub-engines 304 may evaluate subsequent runs in different ways depending on a service's most recently assigned state. (A “run” is an evaluation, by the SSDE 406, of ingested network application service data over a particular interval of time in order to identify the service's state and/or nature, resulting in an identification and assignment by the SSDE 406 of the service's state and/or nature during that particular interval of time. The evaluated network application service data may include any of the kinds of data disclosed herein, such as binary data indicating occurrence or non-occurrence of the service at times within the time interval of the run. For example, if the SSDE 406 evaluates a service every 30 minutes over the course of 3 hours and identifies and assigns a state and/or nature to the service for each such 30-minute time interval, this would involve six 30-minute runs.) The overarching search for stability of state and scale continues as the SSDE 406 performs additional runs, but the way in which the state and scale are evaluated by the Periodicity Engine 420 and Continuity Engine 308 may change, particularly if the assigned state is Periodic or Continuous. As described above, these two states lead the SSDE 406 to latch onto a particular scale, thereby limiting the data that is consumed by the Periodicity Engine 420 and Continuity Engine 422. This allows the SSDE 406 to determine whether the state or scale has changed from its most recent values.

During each run, the SSDE 406 determines a service's latest candidate state by passing the service's service model through the Periodicity Engine 420 and Continuity Engine 422. These engines 420 and 422 determine whether a service exhibits periodic or continuous behavior, as well as the scale at which the behavior is occurring. As stated above, the historical results 432a-n/434a-n of these engines 420 and 422 are then analyzed by the Learning Engine 424 for persistence of state and scale. The mechanics of the Periodicity Engine 420 and Continuity Engine 308 422 now described in certain embodiments of the present invention.

As described above, the SSDE 406 includes a Periodicity Engine 420. In some embodiments of the present invention, the Periodicity Engine 420 implements an ensemble approach that uses four underlying models to determine candidate periodicity values. These models may include, for example, any one or more of the following models, in any combination: Discrete Fourier Transform, Welch's Method, Zero-Crossing, and Auto-Correlation.

After the Periodicity Engine 420 uses such models to determine the candidate values, the Periodicity Engine 420 may calculate a probability score for each of the candidate values, analyzing how closely the underlying service data matches the pattern proposed by the candidate value. For each of the periodicity values, if the periodicity value's probability score falls within a predetermined range, the Periodicity Engine 420 keeps that probability score as a candidate; if the periodicity value's probability score does not fall within the predetermined range, the Periodicity Engine 420 removes the periodicity value from the set of candidates. If no candidates remain, the Periodicity Engine 420 concludes that the data does not display signs of periodicity, and concludes that the service is not Periodic.

If at least one candidate remains, to find a final proposed periodicity value, the Periodicity Engine 420 compares the remaining candidates with one another. If two or more models produce the same (or sufficiently similar) periodicity value for a candidate, then the Periodicity Engine 420 returns that periodicity value as the periodicity value for the candidate. If no two models produce the same (or sufficiently similar) periodicity value for a candidate, then the Periodicity Engine 420 returns the periodicity value with the probability score closest to 1 as the periodicity value for the candidate, because a score closer to 1 indicates a greater affinity between the data and the proposed periodicity value. The following is an example of an algorithm that may be implemented and executed by the Periodicity Engine 420:
1. Given a binary data set, D, calculate a set of candidate periodicity values C:

C={P_{welch},P_{DFT},P_{AC},P_{ZC}}
2.For each periodicity value, P, define set K={k:0≤k<p} and calculate a probability score, F, as:

$${\sum }_{k ∈ K} \frac{1}{\vert S \vert} {\sum }_{i ∈ S} I ( {D}_{i} ) ,$$

where

$$S = \{ k + n P : 0 \leq n < ⌊ \frac{N - k}{P} ⌋$$

### and N=|D|.

3. Compare each periodicity value's probability score, F, against a tolerance range. In one embodiment of the present invention, the range is [0.80,1.5]. If F falls outside the range, then remove the associated periodicity value from C.
4.If C≠0, select a final proposed value from C as:

$${P}_{final} = \{ \begin{matrix}{P}_{m o d e} & if there is only one , unique mode \\ {P}_{close s t} & otherwise\end{matrix}$$

where P_{closest} represents the Periodicity value with score, F, closest to 1.

Like the Periodicity Engine 420, the Continuity Engine 308 (Algorithm 2) analyzes a service's occurrence data for potential state and scale. The Continuity Engine 308 may, for example, include the following elements: baseline scales, baseline probability values, continuity windows, and calculated probability values. Examples of such elements will now be described.

Baseline Scales: Before analyzing a service's data for possible continuity, the Continuity Engine 308 may first determine the space of possible scales at which the service may be continuous. The Continuity Engine 308 may do this by mapping the service's historical data 312 into a set of relevant scales, limited by the time window encapsulated by the data. For example, if a service has a month of data, the set of possible baseline scales may include, for example: 1 day, 3 days, 5 days, 1 week, and 2 weeks.

Baseline Probability Values: Each baseline scale is in turn associated with a baseline probability value. This baseline probability value represents the likelihood that a service occurs in a certain reference interval. For example, if data is collected every thirty minutes, the baseline probability value will relate to the likelihood of occurrence within a thirty minute interval. The Continuity Engine 308 may then scale this value to a chosen confidence level.

Continuity Windows: Similar to baseline scales, continuity windows are defined before the Continuity Engine 308 performs its analysis. These continuity windows are different-sized subsets of the service's historical data 312 that allow the Continuity Engine 308 to evaluate for continuity over different time frames.

Calculated Probability Values: Once the Continuity Engine 308 has defined the possible space of baseline scales, as well as the valid continuity windows on which to evaluate, the Continuity Engine 308 begins its analysis. The analysis runs through each valid continuity window, calculating a bootstrapped probability of occurrence. Bootstrapping is used to remove the time-correlation of the data, serving to better represent the probability of occurrence over a given continuity window.

Analysis Process: With all of these pieces in place, the Continuity Engine 308 makes its final state assignment by evaluating each baseline scale against an appropriate continuity window. If the scale's baseline probability is less than or equal to the continuity window's calculated probability value, then the scale is added to the set of candidate continuity values. In the end, the Continuity Engine 308 finds a service to be continuous if candidates exist. In the case of continuity, the proposed continuity scale is selected to be the minimum scale among all the candidate scales. This value represents the most frequent scale at which the service is continuous.

The following is an example of an algorithm that may be implemented and executed by the Continuity Engine 308:
1. Given a binary data set, D, calculate a set of possible continuity scales, C, appropriate for the use case. The scales in C depend only on: (a) the length of the data set, |D|, and (b) the interval size that each data point represents. For example, if each data point represents a thirty minute interval, then c_{hourly}=2 and C_{daily}=48. Thus: C⊆{i∈Z:0<i≤|D|}.
2. For each scale in C, calculate an associated baseline probability:

$${P}_{scale} = confidence level * \frac{1}{scale} ,$$

where confidence level is a value in [0,1].
3. Similar to (1), define a set of valid continuity windows, W, where each w_i ∈W is a look-back period≤|D| that defines a subset of D. Then define a mapping ƒ:C→W to define the window against which a particular continuity scale will be evaluated.
4. For each window defined by wᵢ ∈W, calculate a bootstrapped probability of occurrence, P_{wi}. If a certain tolerance level is desired, this value can be adjusted using the standard error of the bootstrap estimate.
5. Using the Mapping from (3), Evaluate Each cᵢ ∈C by comparing its P_{ci} to its mapped P_{ƒ(ci)}. If P_{ci}<P_{ƒ(ci)}, then keep cᵢ in C.
6. If C≠ø, then the final proposed continuity scale, c_{final}, is min (C).

As described above, after collecting sufficient data, the SSDE transitions to the learning state where it begins to make use of the Periodicity Engine 420 and Continuity Engine 308 to characterize the service. In each run, the SSDE uses these engines to determine whether the service exhibits periodicity or continuity, along with the frequency or scale at which it is occurring. The SSDE's Learning Engine then checks this historical output 312 for persistence. If the SSDE repeatedly finds Periodicity or Continuity at a consistent scale, then the SSDE categorizes the service as Periodic or Continuous. If the SSDE repeatedly finds Periodicity or Continuity, but not at a consistent scale, then the SSDE characterizes the service as Continuous but Random. Finally, if the SSDE fails to find consistent Periodicity or Continuity, the SSDE will characterize the service as Non-Periodic or Non-Continuous. The Learning Engine runs over a historical dataset 312, H, of state and scale pairs, determined by the Periodicity Engine 420 and Continuity Engine 308. The Learning Engine also takes into account the current state and scale of a service, (S_{current},P_{current}).

To begin, we first define a subset, W⊂H, over which the Learning Engine will check for repetition of behavior. The Learning Engine determines whether all of the states in W are the same. If all of the states in W are determined to be the same, then, in response to that determination, the Learning Engine proceeds to Case 1, below. If not all of the states in W are determined to be the same, then, in response to that determination, the Learning Engine proceeds to Case 2, below.

The following is an example of an algorithm that the Learning Engine may implement and execute in Case 1, according to one embodiment of the present invention:
1. If Sₗₐₜₑₛₜ=S_{current}, then the service's state and scale will remain unchanged, and Case 1 terminates. Otherwise, the Learning Engine proceeds to step 2.
2. If Sₗₐₜₑₛₜ ∈{Continuous,Periodic}, then the Learning Engine checks for stability of scale (see below). Otherwise, the final scale will be 0 and the final state will be:
Non-Continuous if S_{current}=Learning or
Discontinued if S_{current} ∈

{Continuous, Periodic, Continuous but Random}

The Learning Engine checks for stability of scale by: first, finding the most common scale in W, or the max of the modes if there is more than one. The selected scale is referred to as P_{candidate} Next, the Learning engine evaluates the percentage of scales in W that are within a certain tolerance window of P_{candidate}. If this percentage is above a certain threshold, then the scale is said to be stable, and the Learning Engine returns (Sₗₐₜₑₛₜ, P_{candidate}) as output. Otherwise, the Learning Engine returns (Continuous but Random, P_{candidate}).

The following is an example of an algorithm that the Learning Engine may implement and execute in Case 2, according to one embodiment of the present invention:
1. If S_{current} ∈W, then the service's state and scale will remain unchanged, and Case 2 terminates. Otherwise, the Learning Engine proceeds to step 2.
2. If S_{current}=learning, the Learning Engine checks for state time-out to {Non-Continuous} by measuring the cardinality of H. If |H| exceeds a certain value, then the Learning Engine has determined that there is insufficient evidence for periodicity and continuity, and sets the state and scale to (Non-Continuous,0). Otherwise, if S_{current}≠learning, then the Learning Engine defines a timeout window, T⊂H. If the proportion of S_{current} within T exceeds a certain value, then the Learning Engine maintains the state and scale as they are. Otherwise, the Learning Engine returns as output a scale of 0 and a state of either Non-Continuous or Discontinued, depending on the value of S_{current}.

Embodiments of the present invention have a variety of applications. For example, one advantage of embodiments of the SSDE is its ability to identify, categorize, and detect changes in event activity. The following are a few non-limiting examples of use cases related to network security, visually displayed in FIG. 4, as well as ways in which the SSDE may be used in alternative contexts.

As one example, through netflow analysis, Endpoint Detection and Response (EDR) solutions such as CrowdStrike Falcon may be identified by the SSDE. For example, if an administrator knows which workstations are expected to communicate with the EDR solution, the administrator may confirm that these communications are occurring consistently by using the SSDE. Furthermore, by comparing the identified states and scales, the administrator may identify if any machines are:
(a) Failing to communicate with the EDR due to an incomplete config or missing EDR image or license.
(b) Communicating with the EDR at a rate that is significantly different from the other workstations.

This insight gives an administrator greater confidence and oversight into their network security system, and allows them to investigate workstations that are exhibiting unexpected behavior with regards to expected EDR services.

As another example, because the SSDE continues to analyze a service after it has been discovered and assigned to a state, it can also identify when a service has changed its behavior. As such, if an EDR solution has suddenly stopped communicating with a workstation, possibly due to the presence of malware, a change in state from Periodic, Continuous, or Continuous but Random to Discontinuous will arise, and a network administrator will be made aware of the situation. This can lead to further investigation of the service and to early intervention in a potentially threatening attack.

Besides providing a monitor system for network security services, the SSDE may also be used to identify patterns in other types of activity. Any dataset representing event occurrence over time may be modeled using the SSDE, allowing trends and changes in behavior to be identified as they take place.

For example, a network administrator may want to track users' activity levels on a cloud-based service like Office 365. By analyzing users' audit logs with the SSDE, an administrator may discover users' usual rates of activities such as directories accessed and files downloaded, and identify when changes to the normal have occurred. For example, if a user's downloads from a directory have changed in frequency—from sporadic to often—the SSDE will capture such a change and alert an administrator. In this way, the SSDE helps establish baselines for normal activity as well as deviations from historical trends, giving administrators more insight and control over the activities in their networks.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention ingest and analyze network application service data received over a telecommunications network. Such a function cannot be performed mentally or manually. For example, embodiments of the present invention may ingest volumes of such data in time periods that would be impossible to perform mentally or manually. For example, embodiments of the present invention may ingest thousands of data points and analyze those data points to identify and assign a state to a service in under 1 second, in under 10 seconds, or in under 60 seconds, and may do so repeatedly (e.g., continuously). Such a function would be impossible for a human to perform mentally or manually. More generally, embodiments of the present invention are inherently rooted in network communication technology and constitute improvements to such technology.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

APPENDIX: The following is an example of data representing a service and its current and historical states according to one embodiment of the present invention.

```
  {
        “_index”: “services_v1”,
        “_type”: “cyglass”,
        “_id”: “05cac090-8be1-44af-b852-
5c1046600331_dstorganization_80_TCP_NORMAL_CloudFlare Inc.”,
        “_score”: 0,
        “_source”: {
          “app_port”: 80,
          “last_updated”: 1590607800000,
          “srccountry”: “local”,
          “last_idle_period”: 1,
          “srcorganization”: “Untrusted Private”,
          “switch_attempt_count”: 0,
          “dst_type”: “dstorganization”,
          “id”: “05cac090-8be1-44af-b852-
5c1046600331_dstorganization_80_TCP_NORMAL_CloudFlare Inc.”,
          “src_endpoint”: “05cac090-8be1-44af-b852-5c1046600331”,
          “src_display_name”: “VERY_STRICT”,
          “state_start_time”: 1589112000000,
          “src_type”: “src_host_name”,
          “dst_endpoint”: “CloudFlare Inc.”,
          “srcdomainname”: “Not Categorized”,
          “dstinternal”: “External”,
          “data”:
[“90000000001100000000000000000000000000000000000000000000008040200000000000000000000000000000000
00000”,“00000000000000008000000000000000000000000000000000000000000000000000000000004000000000000
00000000000”,“00000000000000000000000000000000000000000000000000380080000000000000000000000000000
00000000000000000”, “000000000000000000000000”],
          “dstorganization”: “CloudFlare Inc.”,
          “src_asset_id”: “05cac090-8be1-44af-b852-5c1046600331”,
          “srclocality”: “Not Categorized, Not Categorized”,
          “historical_values”:[76, 60, 49, 77, 77, 77, 77, 77, 77, 77, 77, 77, 77, 77,
77, 77, 77, 77, 77, 77, 77, 77, 77, 77, 77, 77, 77, 77, 77, 77, 77, 77, 77, 77, 77, 77, 77, 77,
77, 77, 77, 77, 77, 77, 77, 77, 77, 77, 77, 77, 77, 77, 77, 77, 77, 77, 77, 77, 77, 77, 77, 77,
77, 77, 77, 77, 77, 77, 77, 77, 77, 77, 77, 77, 77, 77, 77, 77, 77, 77, 77, 77, 77, 77, 77, 77,
77, 77, 77, 77, 77, 77, 77, 77, 77, 77, 77, 77, 77, 77, 77, 77, 77, 77, 77, 77, 77, 77, 77, 77,
77, 77, 77, 77, 77, 77, 77, 77, 77, 77, 77, 77, 77, 77, 77, 77, 77, 77, 77, 77, 77, 77, 77, 77,
77, 77, 77, 77, 77, 77, 77, 77, 77, 77, 77, 77, 77, 77, 77, 77, 77, 77, 77, 77, 77, 77, 77, 77,
77, 77, 77, 77, 77, 77, 77, 77, 77, 77, 77, 77, 77, 77, 77, 77, 77, 77, 77, 77, 77, 77, 77, 77,
77, 77, 77, 77, 77, 77, 77, 77, 77, 77, 77, 77, 77, 77, 77, 77, 77, 77, 77, 77, 77, 77, 77, 77,
77, 77, 77, 77, 77, 77, 77, 77, 77, 77, 77, 77, 77, 77, 77, 77, 77, 77, 77, 77, 77, 77, 77, 77,
77, 77, 77, 77, 77, 77, 77, 77, 77, 77, 77, 77, 77, 77, 100, 100, 100, 100, 100, 100, 100, 100,
100, 100, 100, 100, 100, 100, 100, 100, 100, 100, 100, 100, 100, 100, 100, 100, 100, 100, 100,
100, 100, 100, 100, 100, 100, 100, 100, 100, 100, 100, 100, 100, 100, 100, 100, 100, 100, 100,
100, 100, 100, 100, 100, 100, 100, 100, 100, 100, 100, 100, 100, 100, 100, 100, 100, 100, 100,
100, 100, 100, 100, 100, 100, 100, 100, 100, 100, 100, 100, 100, 100, 100, 100, 100, 100, 100,
100, 100, 100, 100, 100, 100, 100, 100, 100, 100, 100, 100, 100, 100, 100, 100, 100, 100, 100,
100, 100, 100, 100, 100, 100, 100, 100, 100, 100, 100, 100, 100, 100, 100, 100, 100, 100, 100,
100, 100, 100, 100, 100, 100, 100, 100, 100, 100, 100, 100, 100, 100, 100, 100, 100, 100, 100,
100, 100, 100, 100, 100, 100, 100, 100, 100, 100, 100, 100, 100, 100, 100, 100, 100, 100, 100,
100, 100, 100, 100, 100, 100, 100, 100, 100, 100, 100, 100, 100, 100, 100, 100, 100, 100, 100,
100, 100, 100, 100, 100, 100, 100, 100, 100, 100, 100, 100, 100, 100, 100, 100, 100, 100, 100,
100, 100, 100, 100, 100, 100, 100, 100, 100, 100, 100, 100, 100, 100, 100, 100, 100, 100, 100,
100, 100, 100, 100, 100, 100, 100, 100, 100, 100, 100, 100, 100, 100, 100, 100, 100, 125, 125,
125, 125, 125, 125, 125, 125, 125, 125, 125, 125, 125, 125, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113, 113, 113, 113, 113, 113, 113, 113, 113, 113, 113, 113, 113,
113, 113, 113, 113, 113, 113, 113],
      “value”: 77,
      “state”: “PERIODIC”,
    “historical_states”: [‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’,
‘DIFFERENT_VALUE’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘DIFFERENT_VALUE’, ‘DIFFERENT_VALUE’, ‘DIFFERENT_VALUE’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘DIFFERENT_VALUE’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’, ‘PERIODIC’, ‘PERIODIC’, ‘PERIODIC’, ‘PERIODIC’,
‘PERIODIC’, ‘PERIODIC’, ‘PERIODIC’, ‘PERIODIC’],
          “srcinternal”: “internal”.
          “context”: “dstorganization_80_TCP_NORMAL”,
          “first_updated”: 1588276800000,
          “conv_class”: “TCP_NORMAL”
        }
  }
```

What is claimed is:

1. A method performed by at least one computer processor executing computer program instructions stored on at least one non-transitory computer-readable medium, the method comprising:
(1) collecting service data from a service;
(2) generating, based on the service data, a model of the service;
(3) generating, based on the service data, binary sequence data representing, for each of a plurality of times, the presence or absence of activity of the service at that time;
(4) generating, based on the binary sequence data and the model of the service, a state-scale dataset comprising, for each of a plurality of time intervals, data representing a candidate state of the service during that time interval and a candidate scale of the service during that time interval;
(5) using a learning engine to generate, based on the state-scale dataset, a persistent state and scale of the service.

2. The method of claim 1, wherein the service comprises a network application service, and wherein the service data comprises netflow data collected from the network application service.

3. The method of claim 1, wherein the model of the service comprises data representing:
a source endpoint of the service;
a destination endpoint of the service; and
a context of the service, wherein the context describes an association between the source endpoint and the destination endpoint.

4. The method of claim 1, wherein (5) comprises:
(5)(a) determining, based on the state-scale dataset, whether the service satisfies a periodicity condition;
(5)(b) if the service is determined to satisfy the periodicity condition, then:
(5)(b)(i) identifying a period of the service;
(5)(b)(ii) identifying a scale at which the service satisfies the periodicity condition; and
(5)(b)(iii) determining, based on the state-scale dataset, whether the service has satisfied the periodicity condition repeatedly at a consistent scale; and
(5)(c) if the service is determined to have satisfied the periodicity condition repeatedly at a consistent scale, then assigning a persistent state of Periodic to the service.

5. The method of claim 4, wherein (5) comprises using unsupervised learning to perform (5)(a)-(5)(c).

6. The method of claim 4, wherein (5)(b)(ii) comprises evaluating the service on all possible scales to identify the scale at which the service satisfies the periodicity condition.

7. The method of claim 1, further comprising:
(6) after assigning a state of Periodic to the service, determining that the service no longer exhibits periodicity;
(7) in response to determining that the service no longer exhibits periodicity, assigning a state of Discontinued to the service.

8. The method of claim 4, wherein (5) further comprises:
(5)(d) if the service is not determined to have satisfied the periodicity condition repeatedly at a consistent scale, then determining, based on the state-scale dataset, whether the service satisfies a continuity condition;
(5)(e) if the service is determined to satisfy the continuity condition, then:
(5)(e)(i) identifying a scale at which the service satisfies the continuity condition; and
(5)(e)(ii) determining, based on the state-scale dataset, whether the service has satisfied the continuity condition repeatedly at a consistent scale; and
(5)(f) if the service is determined to have satisfied the continuity condition repeatedly at a consistent scale, then assigning a persistent state of Continuous to the service.

9. The method of claim 8, wherein (5) further comprises:
(5)(g) if the service was determined to satisfy at least one of the periodicity condition and the continuity condition, but not repeatedly at a consistent scale, then assigning a persistent state of Continuous but Random to the service.

10. The method of claim 8, wherein (5) comprises using unsupervised learning to perform (5)(d)-(5)(f).

11. The method of claim 8, wherein (5)(e)(ii) comprises evaluating the service on all possible scales to identify the scale at which the service satisfies the continuity condition.

12. The method of claim 8, further comprising:
(6) after assigning a state of Continuous to the service, determining that the service no longer exhibits periodicity;
(7) in response to determining that the service no longer exhibits periodicity, assigning a state of Discontinued to the service.

13. A system comprising at least one non-transitory computer-readable medium having computer program instructions stored thereon, the computer program instructions being executable by at least one computer processor to perform a method, the method comprising:
(1) collecting service data from a service;
(2) generating, based on the service data, a model of the service;
(3) generating, based on the service data, binary sequence data representing, for each of a plurality of times, the presence or absence of activity of the service at that time;
(4) generating, based on the binary sequence data and the model of the service, a state-scale dataset comprising, for each of a plurality of time intervals, data representing a candidate state of the service during that time interval and a candidate scale of the service during that time interval;
(5) using a learning engine to generate, based on the state-scale dataset, a persistent state and scale of the service.

14. The system of claim 13, wherein the service comprises a network application service, and wherein the service data comprises netflow data collected from the network application service.

15. The system of claim 13, wherein the model of the service comprises data representing:
a source endpoint of the service;
a destination endpoint of the service; and
a context of the service, wherein the context describes an association between the source endpoint and the destination endpoint.

16. The system of claim 13, wherein (5) comprises:
(5)(a) determining, based on the state-scale dataset, whether the service satisfies a periodicity condition;
(5)(b) if the service is determined to satisfy the periodicity condition, then:
(5)(b)(i) identifying a period of the service;
(5)(b)(ii) identifying a scale at which the service satisfies the periodicity condition; and
(5)(b)(iii) determining, based on the state-scale dataset, whether the service has satisfied the periodicity condition repeatedly at a consistent scale; and
(5) (c) if the service is determined to have satisfied the periodicity condition repeatedly at a consistent scale, then assigning a persistent state of Periodic to the service.

17. The system of claim 16, wherein (5) comprises using unsupervised learning to perform (5)(a)-(5)(c).

18. The system of claim 16, wherein (5)(b)(ii) comprises evaluating the service on all possible scales to identify the scale at which the service satisfies the periodicity condition.

19. The system of claim 13, wherein the method further comprises:
(6) after assigning a state of Periodic to the service, determining that the service no longer exhibits periodicity;
(7) in response to determining that the service no longer exhibits periodicity, assigning a state of Discontinued to the service.

20. The system of claim 16, wherein (5) further comprises:
(5)(d) if the service is not determined to have satisfied the periodicity condition repeatedly at a consistent scale, then determining, based on the state-scale dataset, whether the service satisfies a continuity condition;
(5)(e) if the service is determined to satisfy the continuity condition, then:
(5)(e)(i) identifying a scale at which the service satisfies the continuity condition; and
(5)(e)(ii) determining, based on the state-scale dataset, whether the service has satisfied the continuity condition repeatedly at a consistent scale; and
(5)(f) if the service is determined to have satisfied the continuity condition repeatedly at a consistent scale, then assigning a persistent state of Continuous to the service.
